(19) United States
(12) Patent Application Publication
(10) Pub. No.: US 2012/0192565 A1
(43) Pub. Date: Aug. 2, 2012

(54) SYSTEM FOR PREMIXING AIR AND FUEL IN A FUEL NOZZLE

(75) Inventors: Dmitry Vladlenovich Tretyakov, Moscow (RU); Ilya Alexandrovich Slobodyanskiy, Greenville, SC (US); Sergey Victorovich Koshevets, Moscow (RU)

(73) Assignee: General Electric Company, Schenectady, NY (US)

(21) Appl. No.: 13/195,799

(22) Filed: Aug. 1, 2011

(30) Foreign Application Priority Data
Jan. 31, 2011 (RU) 2011103223

(51) Int. Cl. F02C 7/22; B05B 7/04

(52) U.S. Cl. 60/737; 239/398

(57) ABSTRACT

According to various embodiments, a system includes a turbine fuel nozzle. The turbine fuel nozzle includes a first fuel passage extending to a downstream mixing region, a first air passage extending from an exterior of the turbine fuel nozzle to the downstream mixing region, and a second fuel passage extending into the first air passage upstream of the downstream mixing region.

### CROSS-REFERENCE TO RELATED APPLICATION

This application claims priority to and the benefit of Russian Patent Application No. 2011103223, entitled “SYSTEM FOR PREMIXING AIR AND FUEL IN A FUEL NOZZLE”, filed Jan. 31, 2011, which is herein incorporated by reference in its entirety.

### BACKGROUND OF THE INVENTION

The subject matter disclosed herein relates to a gas turbine engine and, more specifically, to a fuel nozzle with fuel-air mixing features to improve combustion and reduce exhaust emissions.

The degree of fuel-air mixing affects combustion and exhaust emissions in a variety of engines, such as gas turbine engines. For example, exhaust emissions include nitrogen oxides (NOx) and carbon monoxide (CO). A diluent may be used to reduce the temperature of combustion, thereby reducing NOx emissions. However, use of diluents increases costs and complexity of the engine.

### BRIEF DESCRIPTION OF THE INVENTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In accordance with a first embodiment, a system includes a turbine fuel nozzle. The turbine fuel nozzle includes an inner annular portion having an inner fuel passage, an outer annular portion disposed about the inner annular portion, and an intermediate annular portion extending between the inner and the outer annular portions. The inner and annular portions define an annular fuel passage upstream of the intermediate annular portion, and the outer annular portion defines a cavity downstream from the intermediate annular portion. The turbine fuel nozzle also includes a first air passage extending through the outer annular portion and the intermediate annular portion from an exterior of the outer annular portion to the cavity, a first fuel passage extending through the intermediate annular portion from the annular fuel passage to the cavity, and a second fuel passage extending through the intermediate annular portion from the annular fuel passage to the first air passage.

In accordance with a second embodiment, a system includes a turbine fuel nozzle. The turbine fuel nozzle includes a first fuel passage extending to a downstream mixing region, a first air passage extending from an exterior of the turbine fuel nozzle to the downstream mixing region, and a second fuel passage extending into the first air passage upstream of the downstream mixing region.

In accordance with a third embodiment, a system includes a turbine engine and a turbine fuel nozzle coupled to the turbine engine. The turbine fuel nozzle includes an internal premixing wall having a first air passage and a first fuel passage, and the first fuel passage couples to the first air passage within the internal premixing wall.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a block diagram of an embodiment of a turbine system having a NO_{X}-reducing fuel nozzle;

FIG. 2 is a cross-sectional side view of an embodiment of the turbine system, as illustrated in FIG. 1, with a combustor having one or more NO_{X}-reducing fuel nozzles;

FIG. 3 is a cutaway side view of an embodiment of the combustor, as illustrated in FIG. 2, having one or more NO_{X}-reducing fuel nozzles coupled to an end cover of the combustor;

FIG. 4 is a perspective view of an embodiment of the end cover and the NO_{X}-reducing fuel nozzles of the combustor, as illustrated in FIG. 3;

FIG. 5 is a cross-sectional side view of an embodiment of the NO_{X}-reducing fuel nozzle, as indicated by line 5-5 in FIG. 4;

FIG. 6 is a cross-sectional side view of an embodiment of the NO_{X}-reducing fuel nozzle, as indicated by line 6-6 in FIG. 4;

FIG. 7 is an exploded front perspective view of an embodiment of the NO_{X}-reducing fuel nozzle;

FIG. 8 is an exploded rear perspective view of an embodiment of the NO_{X}-reducing fuel nozzle;

FIG. 9 is a perspective view of an embodiment of the NO_{X}-reducing fuel nozzle, as illustrated in FIGS. 7 and 8, with dashed lines illustrating internal passages;

FIG. 10 is a top view of an embodiment of the NO_{X}-reducing fuel nozzle, as illustrated in FIGS. 7 and 8, with dashed lines illustrating internal passages;

FIG. 11 is a cross-sectional side view of an embodiment of a portion of the NO_{X}-reducing fuel nozzle as illustrated in FIGS. 1-10;

FIG. 12 is a cross-sectional side view of an embodiment of the NO_{X}-reducing fuel nozzle taken within line 12-12 of FIG. 11, illustrating different arrangements of fuel passages;

FIG. 13 is a cross-sectional side view of an embodiment of the NO_{X}-reducing fuel nozzle taken within line 12-12 of FIG. 11, illustrating different arrangements of fuel passages;

FIG. 14 is a cross-sectional side view of an embodiment of the NO_{X}-reducing fuel nozzle taken within line 12-12 of FIG. 11, illustrating different arrangements of fuel passages;

FIG. 15 is a cross-sectional view of an embodiment of the NO_{X}-reducing fuel nozzle, taken along line 15-15 of FIG. 11, illustrating different axial alignments of the fuel passages relative to an air passage;

FIG. 16 is a cross-sectional view of an embodiment of the NO_{X}-reducing fuel nozzle, taken along line 15-15 of FIG. 11, illustrating different axial alignments of the fuel passages relative to an air passage; and

FIG. 17 is a cross-sectional view of embodiments of the NO_{X}-reducing fuel nozzle, taken along line 15-15 of FIG. 11, illustrating different axial alignments of the fuel passages relative to an air passage.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

The present disclosure is directed to systems for improving fuel-air mixing, combustion, efficiency, and emissions (e.g., NOx emissions) in a gas turbine engine. In general, the gas turbine engine employs one or more fuel nozzles to facilitate fuel-air mixing in a combustor. Each fuel nozzle includes structures to direct air, fuel, and optionally other fluids into the combustor. Upon entering the combustor, a fuel and air mixture combusts, thereby driving the turbine engine. During combustion, compounds such as nitric oxide and nitrogen dioxide (collectively known as NOx), which are subject to governmental regulations, may be formed. NOx emissions formed during the combustion process are a function of fuel composition, operating mode, and combustion equipment design. NOx emissions may be formed via thermal fixation of atomospheric nitrogen in the combustion air (i.e., thermal NOx), rapid formation of nitric oxide near a flame zone (i.e., prompt NOx), or reaction of nitrogen within the fuel with oxygen (i.e., fuel NOx). Driving forces of NOx formation are combustion temperature and time above combustion. In order to reduce NOx emissions, diluents (e.g., steam, water, or flue) may be injected into the combustion zone resulting in a higher operating cost.

Embodiments of the present disclosure provide an improved turbine fuel nozzle design configured to premix air and fuel in the fuel nozzle prior to combustion in order to reduce high temperature zones and NOx emissions. For example, the turbine fuel nozzle may include a downstream cavity defined by an annular wall and a base wall, wherein the base wall includes a plurality of air passages and a plurality of fuel passages, and at least one air passage is coupled to at least one fuel passage to premix air and fuel. In certain embodiments, for example, the plurality of air passages extending from an exterior surface, through the annular wall and the base wall, and into the downstream cavity, while the plurality of fuel passages extend through the base wall, and into the downstream cavity, while the plurality of fuel passages extend through the fuel base wall from an upstream cavity to the downstream cavity. Furthermore, each air passage may be coupled to a diverter fuel passage leading from the upstream cavity, such that a first portion of fuel flows through the plurality of fuel passages and a second portion of fuel flows through the diverter fuel passages into the air passages. For example, the second portion may be 1 to 50 or 10 to 40 percent of the total fuel flow. The diverter fuel passages enable premixing of fuel and air within the air passages, thereby improving fuel-air mixing, improving combustion, and reducing emissions. For example, the premixing may reduce high temperature zones, and thus generation of NOx.

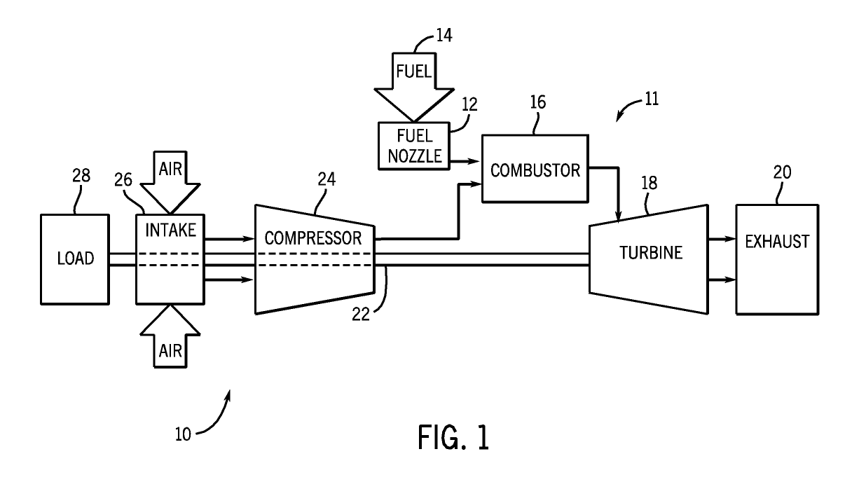

FIG. 1 is a block diagram of an embodiment of a turbine system 10 having a gas turbine engine 11. As described in detail below, the disclosed turbine system 10 employs one or more of fuel nozzles 12 with an improved design to reduce NOx emissions in the turbine system 10. The turbine system 10 may use liquid or gas fuel, such as natural gas and/or a synthetic gas, to drive the turbine system 10. As depicted, the one or more fuel nozzles 12 intake a fuel supply 14, partially mix the fuel with air, and distribute the fuel and the air-fuel mixture into a combustor 16 where further mixing occurs between the fuel and air. The air-fuel mixture combusts in a chamber within the combustor 16, thereby creating hot pressurized exhaust gases. The combustor 16 directs the exhaust gases through a turbine 18 toward an exhaust outlet 20. As the exhaust gases pass through the turbine 18, the gases force turbine blades to rotate a shaft 22 along an axis of the turbine system 10. As illustrated, the shaft 22 is connected to various components of the turbine system 10, including a compressor 24. The compressor 24 also includes blades coupled to the shaft 22. As the shaft 22 rotates, the blades within the compressor 24 also rotate, thereby compressing air from an air intake 26 through the compressor 24 and into the fuel nozzles 12 and/or combustor 16. The shaft 22 may also be connected to a load 28, which may be a vehicle or a stationary load, such as an electrical generator in a power plant or a propeller on an aircraft, for example. The load 28 may include any suitable device capable of being powered by the rotational output of turbine system 10.

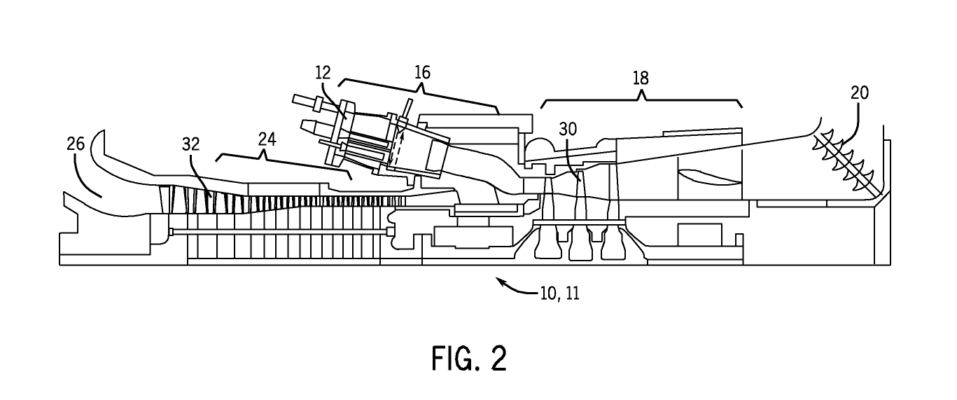

FIG. 2 is a cross-sectional side view of an embodiment of the gas turbine engine 11 as illustrated in FIG. 1. As illustrated, one or more fuel nozzles 12 are located inside one or more combustors 16, wherein each fuel nozzle 12 is configured to partially premix air and fuel within intermediate or interior walls of the fuel nozzles 12 upstream of the injection of air, fuel, or an air-fuel mixture into the combustor 16. For example, each fuel nozzle 12 may divert fuel into air passages, thereby partially premixing a portion of the fuel with air to reduce high temperature zones and NOx emissions. In operation, air enters the gas turbine engine 11 through the air intake 26 and is pressurized in the compressor 24. The compressed air then mixes with gas for combustion within the combustor 16. For example, the fuel nozzles 12 may inject a fuel-air mixture into the combustor 16 in a suitable ratio for optimal combustion, emissions, fuel consumption, and power output. The combustion generates hot pressurized exhaust gases, which then drive turbine blades 30 within the turbine 18 to rotate the shaft 22 and, thus, the compressor 24 and the load 28. The rotation of the turbine blades 30 causes a rotation of the shaft 22, thereby causing blades 32 within the compressor 24 to draw in and pressurize the air received by the intake 26.

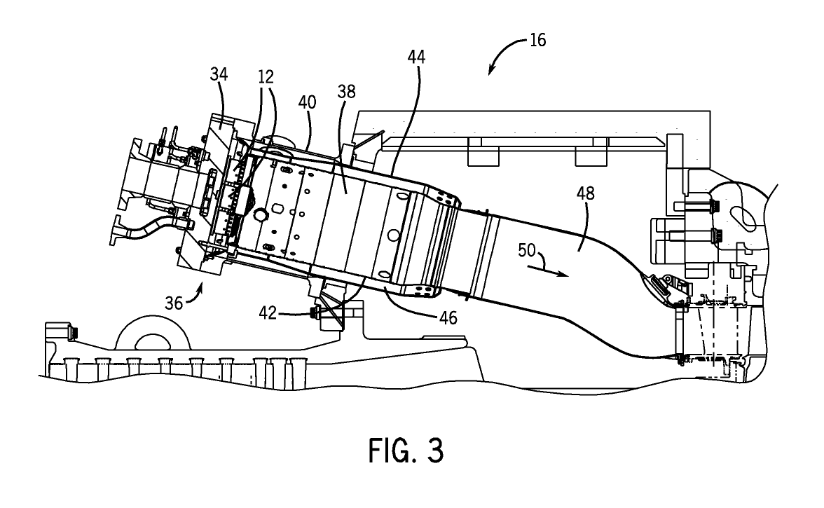

FIG. 3 is a cutaway side view of an embodiment of the combustor 16, as illustrated in FIG. 2. As illustrated, a plurality of fuel nozzles 12 is attached to an end cover 34, near a head end 36 of the combustor 16. Compressed air and fuel are directed through the end cover 34 and the head end 36 to each of the fuel nozzles 12, which distribute a fuel-air mixture into the combustor 16. Again, the fuel nozzles 12 may be configured to partially premix air and with a portion of fuel within the intermediate or interior walls of the fuel nozzles 12 upstream of the injection of air, fuel, or the air-fuel mixture into the combustor 16, thereby reducing the formation of NOx emissions. The combustor 16 includes a combustion chamber 38, which is generally defined by a combustion casing 40, a combustion liner 42, and a flow sleeve 44. In certain embodiments, the flow sleeve 44 and the combustion liner 42 are coaxial with one another to define a hollow annular space 46, which may enable passage of air for cooling and for entry into the head end 36 and the combustion chamber 38. The design of the combustor 16 provides optimal flow of the air-fuel mixture through a transition piece 48 (e.g., converging section) towards the turbine 18. For example, the fuel nozzles 12 may distribute the pressurized air-fuel mixture into the combustion chamber 38, where combustion of the air-fuel mixture occurs. The resultant exhaust gas flows through the transition piece 48 to the turbine 18, as illustrated by arrow 50, causing the blades 30 of the turbine 18 to rotate, along with the shaft 22.

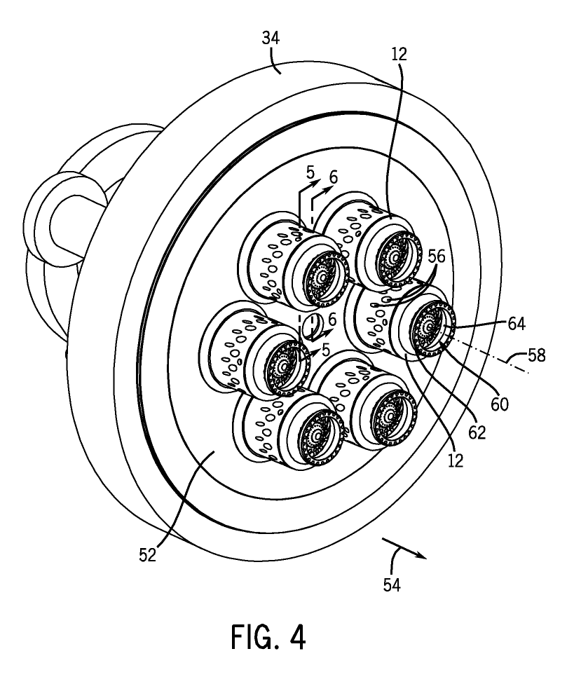

FIG. 4 is a perspective view of an embodiment of the end cover 34 with the plurality of fuel nozzles 12 attached to an end cover surface 52 of the end cover 34. In the illustrated embodiment, the fuel nozzles 12 are attached to the end cover surface 52 in an annular arrangement. However, any suitable number and arrangement of the fuel nozzles 12 may be attached to the end cover surface 52. In certain embodiments, each fuel nozzle 12 premixes air with a portion of the fuel within the intermediate or interior walls of the fuel nozzle 12 prior to being injected from the intermediate or interior wall, thereby reducing the formation of NOx emissions.

Air inlets 56 into the fuel nozzles 12 may be directed inward at an angle, toward an axis 58 of each fuel nozzle 12, thereby enabling an air stream to mix with a fuel stream as it is traveling in a downstream direction 54 into the combustor 16. Further, in certain embodiments, the air streams and the fuel streams may swirl in opposite directions, such as clockwise and counter clockwise, respectively, to enable a better mixing process. In other embodiments, the air streams and the fuel streams may swirl in the same direction to improve mixing, depending on system conditions and other factors.

As discussed in greater detail below, an internal premixing wall may be used within each fuel nozzle 12 to direct a portion of the fuel stream via one or more fuel passages to the air stream in one or more air passages to premix the air stream and fuel stream within the premixing wall. This premixing generates an air-fuel mixture to be injected along with additional fuel streams into a cavity or chamber 60 located within a collar 62 of each fuel nozzle 12. In some embodiments, the fuel passages may be angled relative to the air passages to induce a swirl or counter swirl to mix the air and fuel streams within the premixing wall. In certain embodiments, additional air passages may direct air flow (or another protective fluid) along an inner wall of the fuel nozzle collar 62, thereby generating a blanket of air in the peripheral regions close to an inner wall 64 of the fuel nozzle collar 62. By doing so, the blanket of air reduces the possibility of flame holding in the fuel nozzles 12. As appreciated, certain embodiments of the fuel nozzle 12 may direct only air, only water, or only some other fluid not readily combustible along the interior walls of the fuel nozzle 12.

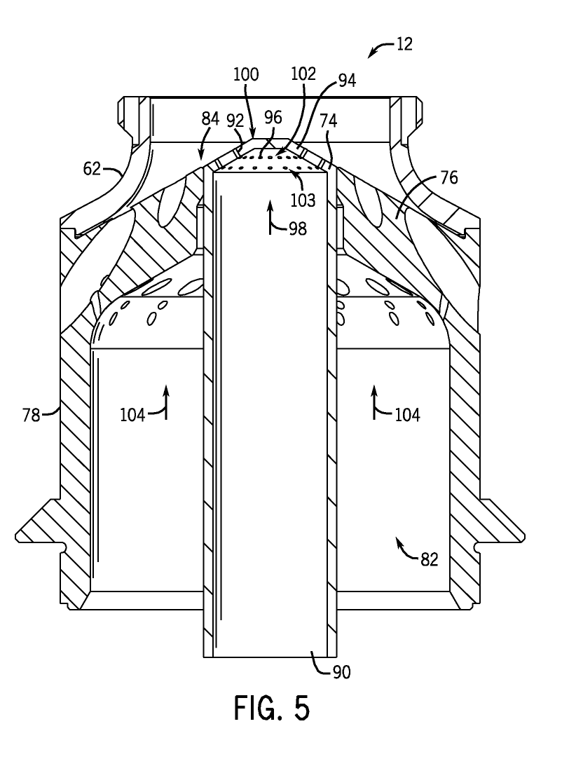

FIG. 5 is a cross-sectional side view of an embodiment of the fuel nozzle 12, as indicated by line 5-5 in FIG. 4, designed to improve fuel-air mixing, improve combustion, and reduce emissions. The fuel nozzle 12 includes an inner wall portion 74 (e.g., an inner annular portion), an intermediate wall portion 76 (e.g., an intermediate annular portion), and outer wall portion 78 (e.g., an outer annular portion). The outer annular portion 78 of the fuel nozzle 12 includes the collar 62. The outer annular portion 78 is disposed about the inner annular portion 74, e.g., coaxial or concentric with one another. The intermediate annular portion 76 extends radially between the inner and outer annular portions 74 and 78, thereby defining upstream cavity or chamber 82 and downstream cavity or chamber 84. The upstream chamber 82 is disposed upstream of the intermediate annular portion 76 between the inner and outer annular portions 74 and 76. The downstream chamber 84 is disposed downstream of the intermediate annular portion 76 within the outer annular portion 78, e.g., inside the collar 62. Thus, the intermediate annular portion 76 may be described as a base wall of the downstream chamber 84, or an internal premixing wall. As discussed in detail below, the intermediate annular portion 76 is configured to premix streams of air and fuel upstream of the chamber 84.

As depicted, the fuel nozzle 12 includes several passages for air and fuel to pass through portions of the fuel nozzle 12. For example, the inner annular portion 74 has fuel passages 92 (e.g., inner fuel passages). Indeed, the fuel passages 92 extend through an end wall 94 of the inner annular portion 74 from fuel inlets 96 facing central fuel passage 90. In certain embodiments, fuel 98 may flow through the fuel inlets 96 to produce fuel streams through the fuel passages 92. As illustrated, the inlets 96 and the passages 92 are arranged in inner and outer annular arrangements 102 and 103 along the end wall 94 at a downstream end 100 of the inner annular portion 74. However, any suitable number and arrangement of the inlets 96 and the passages 92 may be used in the fuel nozzle 12. Also, in certain embodiments, the number of inlets 96 and passages 92 may vary. The number of inlets 94 and corresponding passages 92 may range from approximately 1 to 100 or more. The upstream chamber 82 also defines another fuel passage, e.g., an annular fuel passage, between the inner and annular portions 74 and 78. As discussed in detail below, the upstream chamber 82 (or annular fuel passage) supplies fuel 104 to a plurality of fuel passages, and diverts at least some fuel to a plurality of air passages to enable premixing of fuel and air in the intermediate annular portion 76. In certain embodiments, fuel may only be supplied to the upstream chamber 82 (or annular fuel passage) and not central fuel passage 90, or vice versa.

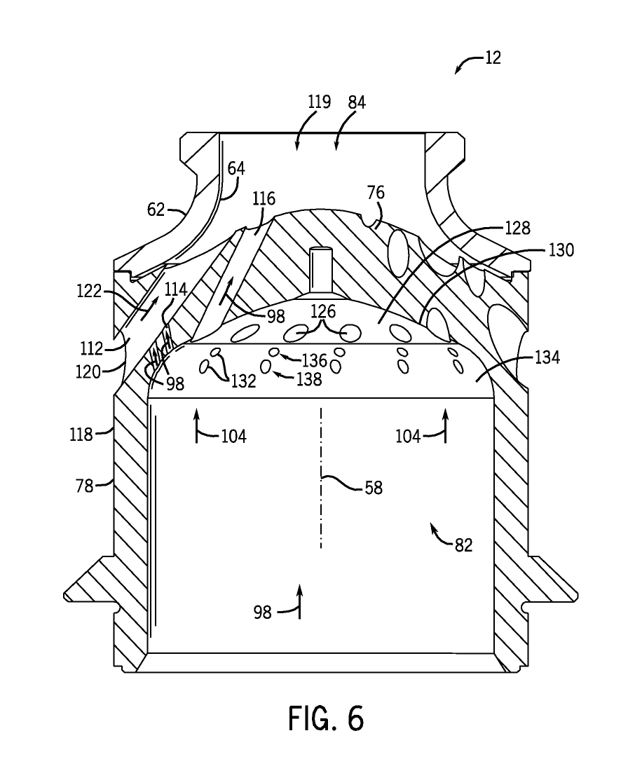

FIG. 6 further illustrates the passages for air and fuel through portions of the fuel nozzle 12. FIG. 6 is a cross-sectional side view of an embodiment of the NO_{X}-reducing fuel nozzle 12, as indicated by line 6-6 in FIG. 4. FIG. 6 is as described above for FIG. 5, except the inner annular portion 74 is not shown. As depicted in FIG. 6, the intermediate annular portion 76 includes air passages 112 and fuel passages 114 and 116 extending through the intermediate annular portion (i.e., internal premixing wall). As depicted, the fuel nozzle 12 includes one or more air passages 112 that extend through the outer annular portion 78 (i.e., outer wall portion 78) and the intermediate annular portion 76 (i.e., inner wall portion or premixing wall) from an exterior 118 of the outer annular portion 78 to the downstream chamber 84. In other words, the air passages 112 extend from the exterior 118 of the fuel nozzle 12, through the internal premixing wall 76, and into an interior 119 of the fuel nozzle 12. The air passages 112 may be angled relative to the axis 58 of the fuel nozzle 12. Air inlets 120 are located on the exterior 118 of the outer annular portion 76. In certain embodiments, air 122 may flow through the air inlets 120 to produce air streams through the air passages 112. In certain embodiments, the number of inlets 120 and passages 112 may vary. For example, the number of inlets 120 and corresponding passages 112 may range from approximately 1 to 50, 1 to 25, or 1 to 10. In further embodiments and as shown in FIGS. 7-10, the fuel nozzle 12 may include additional air passages to direct air flow (or another protective fluid) along the inner wall 64 of the fuel nozzle collar 62, thereby generating a blanket of air in the peripheral regions close to the inner wall 64 of the fuel nozzle collar 62 to reduce the possibility of flame holding in the vicinity of the fuel nozzle 12.

As mentioned above, the fuel nozzle 12 includes another fuel passage 104 (e.g., annular fuel passage). As depicted, one or more fuel passages 116 extend through the intermediate annular portion 76 (i.e., inner wall portion) from upstream chamber 82 of the annular fuel passage 104 to downstream chamber 84. The fuel passages 116 may be angled relative to the axis 58 of the fuel nozzle 12. Fuel inlets 126 are located on a central portion 128 of an inner face 130 of the intermediate annular portion 76. In certain embodiments, fuel 98 may flow through the fuel inlets 126 to produce fuel streams through the fuel passages 116. As illustrated, the inlets 126 and the passages 116 are in an annular arrangement at and within the intermediate annular portion 76. However, any suitable number and arrangement of the inlets 126 and the passages 116 may be disposed in the fuel nozzle 12. For example, the number of inlets 126 and corresponding passages 116 may range from approximately 1 to 40, 1 to 20, or 1 to 10.

Also, one or more fuel passages 114 extend through the intermediate annular portion 76 (i.e., inner wall portion) from upstream chamber 82 of the annular fuel passage 104 to one or more air passages 112. The coupling of the fuel passages 114 to the air passages 112 allows the premixing of fuel 98 with air 122 within the air passages 112 of the internal premixing wall 76. As described in detail below, the fuel passages 114 may be angled relative to airflow paths through the air passages 112. Fuel inlets 132 are located on a peripheral portion 134 of the inner face 130 of the intermediate annular portion 76. In certain embodiments, fuel 98 may flow through the fuel inlets 132 to produce fuel streams through the fuel passages 114. As illustrated, the inlets 132 and the passages 114 are in annular arrangements at and within the intermediate annular portion 76. As depicted, the inlets 132 and the passages 114 are disposed in an inner annular arrangement 136 and an outer annular arrangement 138. However, any suitable number and arrangement of the inlets 132 and the passages 114 may be used in the fuel nozzle 12. For example, the number of inlets 132 and corresponding passages 114 may range from approximately 1 to 80, 1 to 40, 1 to 20, or 1 to 10. As mentioned above, the coupling of the fuel passages 114 to the air passages 112 allows a portion of the fuel 98 to mix with air 122. For example, 5 to 50 or 10 to 35 percent of the total fuel supplied from each fuel nozzle 12 to the combustion zone may be diverted through the fuel passages 114 to the air passages 112. The percentage may be based on mass flow rate, volume, or any other comparable measure of fuel flow. This allows some of the fuel 98 to be premixed with the air 122 prior to injection into downstream chamber 84, thus, allowing the reduction in both high temperature zones and NOx emissions. Fuel 98 is also supplied to the downstream chamber 84 via fuel passages 92 and 116. Also, as mentioned above, air 122 is supplied via additional air passages to form the blanket of air along the inner wall 64 of the collar 62 to reduce the chances of flame holding in the vicinity of the fuel nozzle 12.

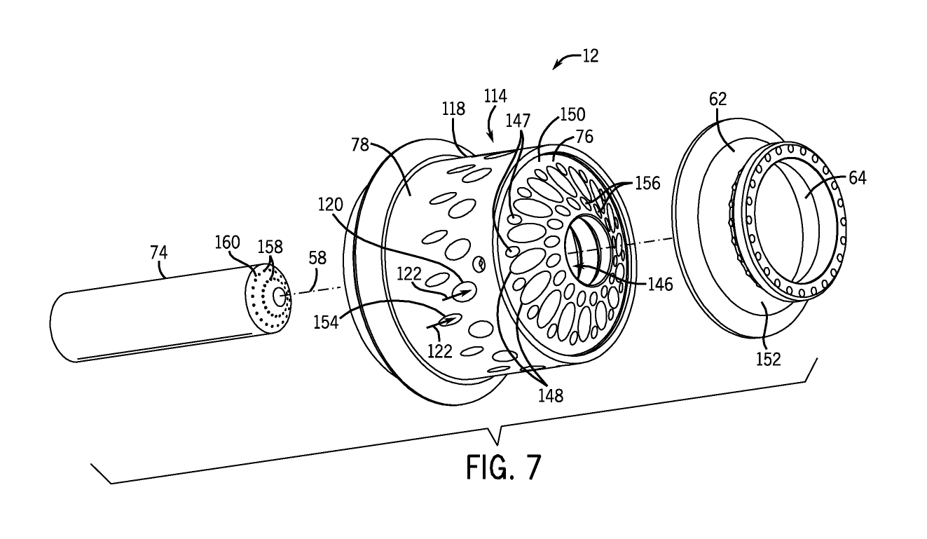

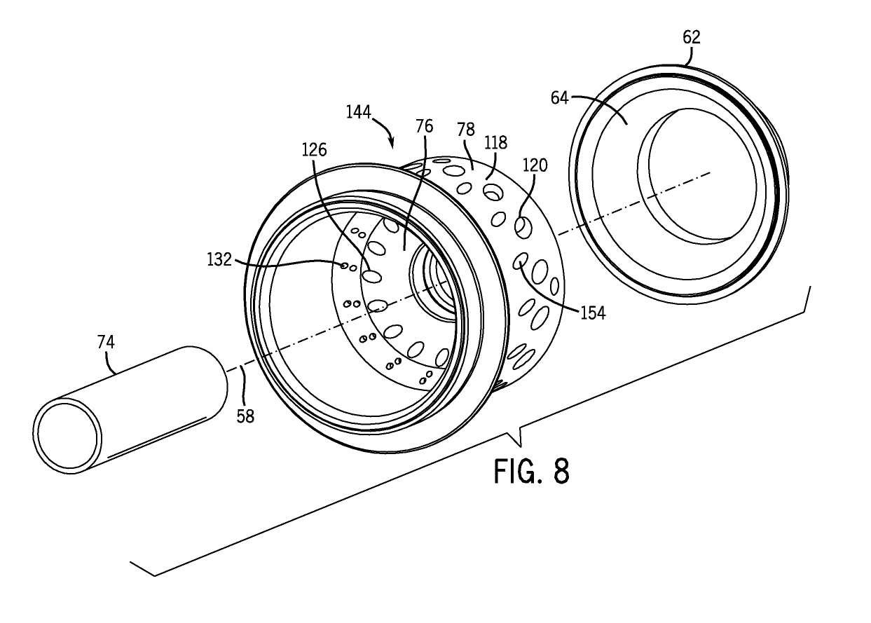

FIGS. 7 and 8 are exploded views of embodiments of the NO_{X}-reducing fuel nozzle 12 of FIGS. 5 and 6, illustrating how the components fit together to form the fuel nozzle 12. As illustrated, the fuel nozzle 12 includes the collar 62, a main body 144, and the inner annular portion 74. The main body 144 includes the outer annular portion 78 and the intermediate annular portion 76 as described above. As illustrated, the inner annular portion 74 is generally configured to fit securely within a circular opening 146 through the main body 144 along the axis 58 of the fuel nozzle 12. As depicted, the inner annular portion 74 and the main body 144 are separate parts of the fuel nozzle 12. As separate parts, separate fuels may be directed through the inner annular portion 74 and the intermediate annular portion of the 76 of the main body 144. In certain embodiments, the inner annular portion 74 and the main body 144 may be integrated into one part. Also, as depicted, the main body 144 and the collar 62 are separate parts. In certain embodiments, the main body 144 and the collar 62 may be integrated into one part.

As illustrated, the collar 62 is generally located near the intermediate annular portion 76 of the main body 144, such that the collar 62 is located above air outlets 147 and portions of air outlets 148 annularly arranged along an outer face 150 of the intermediate annular portion 76. A neck 152 of the collar 62 may have a diameter less than the diameter of the intermediate annular portion 76. This configuration allows air 122 that enters via air inlets 154, located circumferentially along the outer annular portion 78, to exit via air outlets 147 to form the blanket of air 122 along the inner wall 64 of the collar 62 to reduce the possibility of flame holding in the vicinity of the fuel nozzle 12.

As illustrated, the outer annular portion 78 of the main body 144 includes air inlets 120 spaced circumferentially along the outer surface 118. Corresponding air outlets 148 are annularly arranged along the outer face 150 of the intermediate annular portion 76 between air outlets 147 and fuel outlets 156. As described above in FIG. 6, air 122 enters via air inlets 120 and is premixed with fuel 98 in the air passages 112. Fuel 98 enters via the fuel inlets 132, as described above, and enters the air passages 112 via the fuel passages 114. The air-fuel mixture then exits the air passages 112 via the air outlets 148. As mentioned above, the premixing of the air 122 and the fuel 98 in the interior premixing wall 76 reduces the formation of high temperature zones and NOx emissions. Besides fuel 98 in the air-fuel mixture, fuel 98 may exit the fuel outlets 156 annularly arranged along the outer face 150 of the intermediate annular portion 76 as well as the fuel outlets 158 annularly arranged along an outer face 160 of the inner annular portion 74. As described above, fuel 98 enters via the fuel inlets 126 into the fuel passages 116, and then exits via fuel outlets 156. As illustrated, the outlets 1476, 148, 156, and 158 are in annular arrangements. However, any suitable number and arrangement of the outlets 147, 148, 156, and 158 may be used in the fuel nozzle 12. Also, as illustrated, the inlets 120 and 154 are in arrangements spaced circumferentially along the outer annular portion 78. However, any suitable number and arrangement of the inlets 120 and 154 may be used in the fuel nozzle 12.

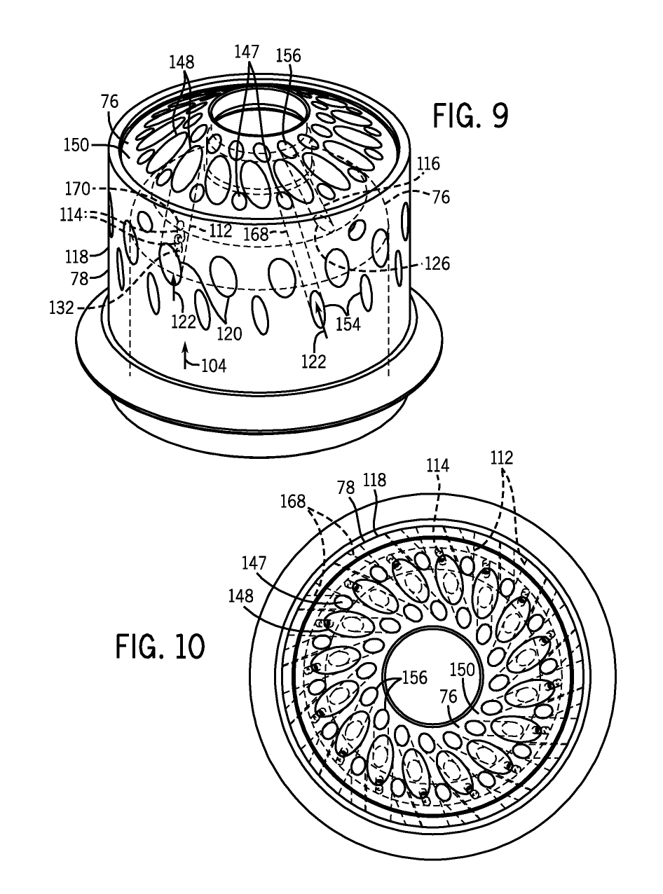

As described above, in certain embodiments, the components of the fuel nozzle 12 facilitate the premixing of air and fuel upstream of the downstream chamber 84 within the internal premixing wall 76, thus, reducing the formation of high temperature zones and NOx emissions. For example, FIGS. 9 and 10 are perspective and top views, respectively, of an embodiment of the NO_{X}-reducing fuel nozzle 12, as illustrated in FIGS. 7 and 8, with dashed lines illustrating some, but not all, internal passages. As illustrated, the main body 144 of the fuel nozzle 12 includes air passages 112 and 168 that extend through the outer annular portion 78 to the intermediate annular portion 76 from the exterior 118 of the outer annular portion 78 to the outer face 150 of the intermediate annular portion 76. Air passages 112 extend from air inlets 120 to air outlets 148. As described above, in certain embodiments, air 122 may flow through the air inlets 120 to produce air streams through the air passages 112 to premix with fuel 98. Air passages 168 extend from air inlets 154 to air outlets 147. As described above, in certain embodiments, air 122 may flow through the air inlets 154 to produce air streams through the air passages 168 to form the blanket of air 122 along inner wall 64 of the collar 62 to reduce the chances of flame holding in the vicinity of the fuel nozzle 12.

As illustrated, in certain embodiments, the main body 144 of the fuel nozzle 12 includes fuel passages 114 and 116 that extend through the intermediate annular portion 76 from the annular fuel passage 104. Fuel passages 116 extend from fuel inlets 126 to fuel outlets 156. As described above, in certain embodiments, fuel 98 may flow through the fuel inlets 126 to produce fuel streams through the fuel passages 116. Fuel passages 114 extend from fuel inlets 132 to fuel outlets 170 located within air passages 112. As described above, in certain embodiments, fuel 98 may flow through the fuel inlets 132 to produce fuel streams through the fuel passages 114 to premix with the air 122 within air passages 112.

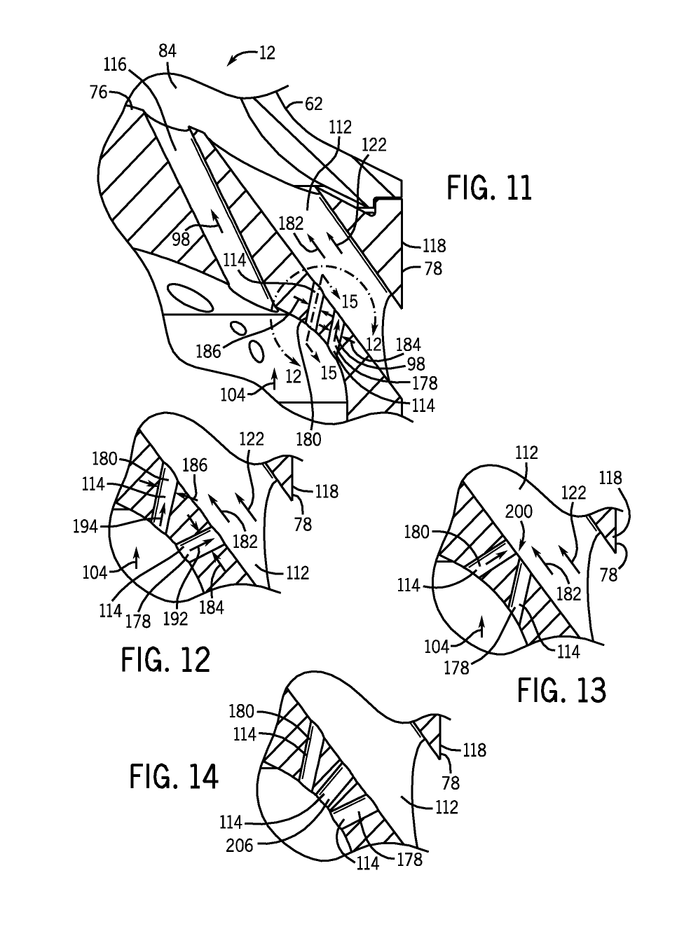

FIGS. 11-17 illustrate various embodiments for premixing fuel 98 and air 122 within the internal premixing wall 76 of the NO_{X}-reducing fuel nozzle 12. FIG. 11 is a cross-sectional side view of an embodiment of a portion of the NO_{X}-reducing fuel nozzle 12, illustrating an arrangement of air passage 112 and fuel passages 114 and 116. As described above, the air passage 112 extends through the outer annular portion 78 (i.e., outer wall portion) and the intermediate annular portion 76 (i.e., inner wall portion) from the exterior 118 of the outer annular portion 78 to the downstream chamber 84. Also, as described above, the fuel passage 116 extends through the intermediate annular portion 76 from the annular fuel passage 104 to downstream chamber 84. Also, one or more fuel passages 114 extend through the intermediate annular portion 76 from the annular fuel passage 104 to the air passage 112. As described above, air 122 flows from the exterior 118 of the outer annular portion 78 to downstream chamber 84 via air passage 112. Fuel 98 flows from the inner annular fuel passage 104 to the air passage 112 via the fuel passages 114. Fuel 98 from the fuel passages 114 premixes with the air 122 within air passage 112 within the internal premixing wall 76 prior to exiting to the downstream chamber 84. This premixing of air 122 and fuel 98 reduces high temperature zones as well as NOx emissions.

As illustrated, two fuel passages 178 and 180 are coupled to the air passage 112. However, any suitable number of fuel passages 114 may extend from the annular fuel passage 104 and couple to the air passage 112. The number of fuel passages 114 coupled to each air passage 112 may range from approximately 1 to 15, 1 to 10, or 1 to 5. For example, 1, 2, 3, 4, or 5 fuel passages 114 may be coupled to each air passage 112. As depicted, the fuel passages 178 and 180 are angled in a same downstream direction relative to an airflow path 182 (i.e., with the stream of airflow) through the air passage 112. Also, the fuel passages 178 and 180 are parallel with respect to each other. However, any suitable arrangement of the fuel passages 114 may be used as described in further detail below. Further, the fuel passages 178 and 180 each include a diameter 184 and 186, respectively, which are the same relative to each other. As discussed in further detail below, the diameters 184 and 186 of the fuel passages 178 and 180 may be different.

As mentioned above, the number and the arrangement of the fuel passages 114 may vary. FIGS. 12-14 are cross-sectional side views of embodiments of the NO_{X}-reducing fuel nozzle 12, illustrating different arrangements of the fuel passages 114. For example, FIG. 12 depicts fuel passages 178 and 180 in an arrangement with the passages 178 and 180 non-parallel relative to one another. Fuel passage 180 is angled in the downstream direction relative to the airflow path 182, while fuel passage 178 is angled in an upstream direction relative to the airflow path 182 (i.e., against the stream of airflow) through the air passage 112. In other words, the fuel passages 178 and 180 include fuel paths 192 and 194 directed into the air passage 112 in diverging directions. Directing the fuel path 192 upstream against the stream of airflow may allow the air 122 and fuel 98 to mix better. Further, fuel passage 178 includes diameter 184, which is different than diameter 186 of fuel passage 194. As illustrated, the diameter 184 is greater than diameter 186, thus, diverting more fuel against the stream of airflow than with the stream of airflow to better premix a larger portion of the fuel 98, diverted from the annular fuel passage 104 to the fuel passages 114, with the air 122. However, in certain embodiments, the diameter 186 may be greater than diameter 184 to divert more fuel with the stream of airflow than against the stream of airflow.

Alternatively in FIG. 13, in another non-parallel arrangement, fuel passage 178 is angled in the downstream direction, while fuel passage 180 is slightly angled in the upstream direction relative to the airflow path 182. In other words, the fuel passages 178 and 180 include fuel paths 192 and 194 directed into the air passage 112 in converging directions. Concentrating the fuel 98 into an area of convergence may increase the amount of fuel 98 premixed with the air 122 and, thus, reduce the formation of high temperature zones and NOx emissions.

Further in FIG. 14, in another non-parallel arrangement, fuel passage 178 is angled in the upstream direction, fuel passage 206 is angled in an intermediate direction approximately perpendicular to the airflow path 182, and fuel passage 180 is angled in the downstream direction relative to the airflow path 182. The various arrangements in FIGS. 11-14 are configured to premix fuel 98 with air 122 in the air passage 112 within the internal premixing wall 76 in order to reduce the formation of high temperature zones and NOx emissions.

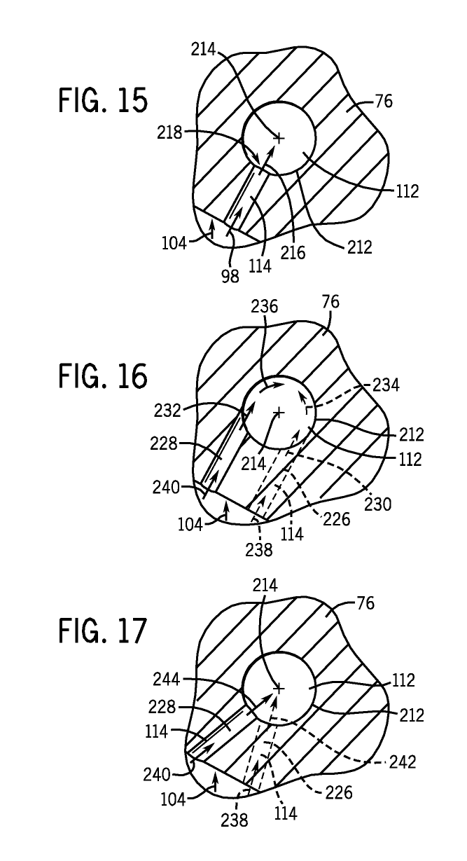

The fuel passages 114 may be aligned within the same axial position or oriented along different axial positions to create different effects in the premixing of the air 122 and fuel 98. FIGS. 15-17 are cross-sectional views of embodiments of the NO_{X}-reducing fuel nozzle 12, taken along line 12-12 of FIG. 11, illustrating different axial alignments of the fuel passages 114 relative to the air passage 112, e.g., axis 214. For example, FIG. 15 illustrates the alignment of one or more fuel passages 114 within the same axial alignment about a circumference 212 as well as central axis 214 of the air passage 112. As a result, fuel 98 within fuel paths 216 exits generally from a same point 218 about the circumference 212 of the air passage 112 towards the central axis 214 of the passage 112. Within the same axial alignment relative to axis 214, the fuel passages 114 may be parallel or non-parallel with respect to each other at different axial positions along the axis 214. In addition, the fuel passages 114 may be directed into the air passage 112 in the upstream, perpendicular, or downstream directions. Further, the fuel paths 216 of the fuel passages 114 may be directed into the air passage 112 in converging or diverging directions.

However, as noted above, the fuel passages may be oriented along different axial positions relative to the air passage 112, e.g., axis 214. For example, FIG. 16 illustrates the alignment of fuel passages 226 and 228 at different axial positions along the axis 214, as indicated by solid and dashed lines of passages 226 and 228. In addition, fuel passages 226 and 228 are located at different circumferential positions about the circumference 212 of the air passage 112. Indeed, both fuel passages 226 and 228 are angled in directions 230 and 232 (i.e., swirl inducing directions), respectively, offset from the central axis 214 of the air passage 112. Individually, each fuel passage 226 and 228 creates a swirling flow path of fuel 98, generally indicated by arrows 234 and 236, respectively, about the central axis 214 in the air passage 112. In the illustrated embodiments, the fuel passages 226 and 228 are tangent to the circumference 212, and are generally parallel to one another. In other embodiments, the fuel passages 226 and 228 may be angled differently toward the air passage 112. As illustrated, the fuel passages 226 and 228 include fuel paths 238 and 240 directed into air passage 112 in opposite directions 230 and 232 about the central axis 214 of the air passage 112 to generate counter swirl (i.e., swirl in clockwise an counter-clockwise directions), as generally indicated by arrows 234 and 236, about the central axis 214 to enable a better mixing process. The fuel passages 226 and 228 may be directed into the air passage 112 in the upstream, perpendicular, or downstream directions along the axis 214. In addition, the fuel paths 238 and 240 of the fuel passages 226 and 228 may be directed into the air passage 112 in converging or diverging directions.

Alternatively, as shown in FIG. 17, the fuel passages 226 and 228 may be at different axial positions, but with the flow of fuel 98 directed towards the central axis 214 of the air passage 112. As illustrated, the fuel passages 226 and 228 are located at different axial positions along the axis 214, as indicated by solid and dashed lines of passages 226 and 228. In addition, the fuel passages 226 and 228 are directed toward the air passage 112 in non-parallel directions, as indicated by fuel paths 238 and 240. As illustrated, the fuel paths 238 and 240 of the fuel passages 238 and 240 are directed toward the central axis 214 in converging directions, as generally indicated by arrows 242 and 244. The fuel passages 238 and 240 may be directed into the air passage 112 in the upstream, perpendicular, or downstream directions. The convergence of the fuel 98 towards the central axis 214 may premix more fuel 98 with the air 122. Indeed, all of the various arrangements of the fuel passages above are directed towards premixing fuel 98 with air 112 within the premixing wall 76 prior to injection of the air-fuel mixture into downstream chamber 84. As a result of the premixing, the formation of high temperature zones and NOx emissions may be reduced in the fuel nozzle 12.

Technical effects of the disclosed embodiments include providing systems to reduce high temperature zones and NOx emissions with the combustion zone. In addition, the systems reduce the possibility of flame holding within the vicinity of the fuel nozzle 12. The embodiments disclosed herein help to reduce high temperature zones and NOx emissions by premixing fuel a portion of the total injected fuel with air within an internal premixing wall 76 of the fuel nozzle 12. Premixing of the air and fuel upstream of the cavity 80 of the fuel nozzle 12 results in a greater reduction in high temperature zones and NOx emissions than solely mixing the air and fuel within the cavity 80. Reducing the high temperature zone and NOx emissions, via premixing of the air and fuel within the internal premixing wall 76, allows less diluent to be used in efforts to reduce NOx emissions. In addition, the disclosed embodiments reduce the operating costs associated with reducing NOx emissions. Further, the fuel nozzle 12 may include additional air passages to direct air flow (or another protective fluid) along the inner wall 64 of the fuel nozzle collar 62, thereby generating a blanket of air in the peripheral regions close to the inner wall 64 of the fuel nozzle collar 62 to reduce the possibility of flame holding in the vicinity of the fuel nozzle 12.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A system, comprising:
a fuel nozzle, comprising:
an inner annular portion having an inner fuel passage;
an outer annular portion disposed about the inner annular portion;
an intermediate annular portion extending between the inner and outer annular portions, wherein the inner and outer annular portions define an annular fuel passage upstream of the intermediate annular portion, and the outer annular portion defines a cavity downstream from the intermediate annular portion;
a first air passage extending through the outer annular portion and the intermediate annular portion from an exterior of the outer annular portion to the cavity;
a first fuel passage extending through the intermediate annular portion from the annular fuel passage to the cavity; and
a second fuel passage extending through the intermediate annular portion from the annular fuel passage to the first air passage.

2. The system of claim 1, wherein the second fuel passage is angled in an upstream direction relative to an airflow path through the first air passage.

3. The system of claim 1, wherein the second fuel passage is angled in a downstream direction relative to an airflow path through the first air passage.

4. The system of claim 1, wherein the second fuel passage is angled in a direction offset from a central axis of the first air passage to create a swirling flow path of fuel about the central axis in the first air passage.

5. The system of claim 1, comprising a third fuel passage extending through the intermediate annular portion from the annular fuel passage to the first air passage.

6. The system of claim 5, wherein the second and third fuel passages are non-parallel relative to one another.

7. The system of claim 5, wherein the second and third fuel passages have different diameters relative to one another.

8. The system of claim 5, wherein the second and third fuel passages comprise fuel paths directed into the first air passage in opposite directions about a central axis of the first air passage to generate counter swirl of fuel about the central axis.

9. The system of claim 5, wherein the second and third fuel passages comprise fuel paths directed into the first air passage in converging directions.

10. The system of claim 1, comprising a plurality of first air passages and a plurality of second fuel passages, wherein each first air passage of the plurality of first air passages extends through the outer annular portion and the intermediate annular portion from the exterior of the outer annular portion to the cavity, and each second fuel passage of the plurality of second fuel passages extends through the intermediate annular portion from the annular fuel passage to at least one first air passage of the plurality of first air passages.

11. The system of claim 10, comprising a plurality of first fuel passages, wherein each first fuel passage of the plurality of first fuel passages extends through the intermediate annular portion from the annular fuel passage to the cavity.

12. The system of claim 10, comprising a plurality of second air passages, wherein each second air passage of the plurality of second air passages extends through the outer annular portion and the intermediate annular portion from the exterior of the outer annular portion to the cavity.

13. The system of claim 1, comprising at least one of a turbine combustor or a turbine engine having the fuel nozzle.

14. A system, comprising:
a turbine fuel nozzle, comprising:
a first fuel passage extending to a downstream mixing region;
a first air passage extending from an exterior of the turbine fuel nozzle to the downstream mixing region; and
a second fuel passage extending into the first air passage upstream of the downstream mixing region.

15. The system of claim 14, comprising:
a first chamber;
a second chamber downstream from the first chamber;
an outer wall portion surrounding the first and second chambers;
an inner wall portion disposed within the outer wall portion, wherein the inner wall portion separates the first and second chambers;
the first air passage extending through the outer wall portion and the inner wall portion from the exterior of the outer wall portion to the second chamber;
the first fuel passage extending through the inner wall portion from the first chamber to the second chamber; and
the second fuel passage extending through the inner wall portion from the first chamber to the first air passage.

16. The system of claim 14, wherein the second fuel passage is angled in an upstream direction, a downstream direction, a swirl inducing direction, or a combination thereof, relative to an airflow path through the first air passage.

17. The system of claim 15, comprising a plurality of first air passages and a plurality of second fuel passages, wherein each first air passage of the plurality of first air passages extends through the outer wall portion and the inner wall portion from the exterior of the outer wall portion to the second chamber, and each second fuel passage of the plurality of second fuel passages extends through the inner wall portion from the first chamber to at least one first air passage of the plurality of first air passages.

18. A system, comprising:
a turbine engine; and
a turbine fuel nozzle coupled to the turbine engine, wherein the turbine fuel nozzle comprises an internal premixing wall having a first air passage and a first fuel passage, and the first fuel passage couples to the first air passage within the internal premixing wall.

19. The system of claim 18, wherein the first air passage extends from an exterior of the turbine fuel nozzle, through the internal premixing wall, and into an interior of the turbine fuel nozzle.

20. The system of claim 19, comprising a second fuel passage coupled to the first air passage within the internal premixing wall.
